(19) United States
(12) Patent Application Publication
(10) Pub. No.: US 2009/0125953 A1
(43) Pub. Date: May 14, 2009

(54) SYSTEMS, METHODS AND GRAPHICAL USER INTERFACES FOR MONITORING AN INTERNET PROTOCOL TELEVISION (IPTV) NETWORK

(75) Inventors: JASON C. PORTER, FRISCO, TX (US); KENNETH WINBURN, WEATHERFORD, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T KNOWLEDGE VENTURES, L.P., RENO, NV (US)

(21) Appl. No.: 12/104,147

(22) Filed: Apr. 16, 2008

Related U.S. Application Data
(60) Provisional application No. 60/986,570, filed on Nov. 8, 2007.

(51) Int. Cl. H04N 7/173

(52) U.S. Cl. 725/109; 715/719; 725/114; 725/118; 725/144

(57) ABSTRACT

Systems, methods and graphical user interfaces monitoring an Internet Protocol Television (IPTV) network are provided. A particular method includes receiving IPTV process data. The IPTV process data includes information about a plurality of processes executing at a plurality of servers of an IPTV distribution network. The method also includes analyzing the IPTV process data to determine process operational information. The process operational information is descriptive of the operation of at least a first process of the plurality of processes and operation of at least a second process of the plurality of processes. The method also includes generating a display based on the operational information. The display includes an aggregate display element representing the operation of the at least one first process and the operation of the at least one second process.

### CLAIM OF PRIORITY

This application claims priority from U.S. Provisional Patent Application No. 60/986,570, entitled “SYSTEMS, METHODS AND GRAPHICAL USER INTERFACES FOR MONITORING AN INTERNET PROTOCOL TELEVISION (IPTV) NETWORK”, filed on Nov. 8, 2007, which is incorporated herein by reference in its entirety.

### FIELD OF THE DISCLOSURE

The present disclosure is generally related to an Internet Protocol Television (IPTV) network.

### BACKGROUND

Internet Protocol Television (IPTV) networks can include many servers executing a large number of processes. The server may, for example, process video, access requests, acquire content, distribute the content, manage access rights, and so forth. Additionally, many of the servers may be geographically distant from other servers. Further, certain of the servers may be interdependent. That is, various servers may execute processes that require information from or provide information to other of the servers. This complex environment can make monitoring the various severs and processes of the IPTV network very complex. Hence, there is a need for an improved system, method and graphical user interface for monitoring an IPTV network.

### BRIEF DESCRIPTION OF THE DRAWINGS

FIG. 1 is a diagram of a particular embodiment of a system for monitoring an IPTV network;

FIG. 2 is block diagram of a first particular embodiment of a system for monitoring an IPTV network;

FIG. 3 is an illustration of an embodiment of graphical user interface for monitoring an IPTV network;

FIG. 4 is a diagram of a second particular embodiment of a system for monitoring an IPTV network;

FIG. 5 is a flow chart of a particular embodiment of a method of monitoring an IPTV network; and

FIG. 6 is a diagram of an illustrative computing system.

### DETAILED DESCRIPTION OF THE DRAWINGS

Systems, methods and graphical user interfaces for monitoring an Internet Protocol Television (IPTV) network are disclosed. In a particular embodiment, a method includes receiving IPTV process data. The IPTV process data includes information about a plurality of processes executing at a plurality of servers of an IPTV distribution network. The method also includes analyzing the IPTV process data to determine process operational information. The process operational information is descriptive of the operation of at least one first process of the plurality of processes and the operation of at least one second process of the plurality of processes. The method also includes generating a display based on the operational information. The display includes an aggregate display element representing the operation of the at least one first process and the operation of the at least one second process.

In another particular embodiment, a graphical user interface (GUI) for monitoring an Internet Protocol Television (IPTV) network includes an aggregate graphical display element. The aggregate display element includes a graphical representation of process operational information of a first process at a first server of an IPTV network and of process operational information of a second process at the first server of the IPTV network.

In another particular embodiment, a system includes an operations manager to receive Internet Protocol Television (IPTV) application data from an IPTV network. The IPTV application data is associated with one or more IPTV software applications, and the one or more IPTV software applications are adapted to provide IPTV service to one or more subscriber premises. The system also includes a data repository to collect a portion of the IPTV application data based on one or more rules. The system also includes a data analysis module. The data analysis module is adapted to analyze the collected IPTV application data, and to send status data to a dashboard module. The status data indicates a measure of performance associated with at least a first IPTV software application of the one or more IPTV software applications.

In another particular embodiment, a system includes a data repository to receive first application data from a first server of an Internet Protocol Television (IPTV) network. The first application data is associated with one or more first IPTV software applications, and the one or more first IPTV software applications are adapted to provide IPTV service to a first group of subscriber premises. The data repository also receives second application data from a second server of an Internet Protocol Television (IPTV) network. The second application data is associated with one or more second IPTV software applications, and the one or more second IPTV software applications are adapted to provide IPTV service to one or more subscriber premises. The system also includes a data analysis module to analyze the first application data to determine a condition of at least one of the first IPTV software applications and to analyze the second application data to determine a condition of at least one of the second IPTV software applications. The data analysis module also sends condition data to a graphical user interface module. The condition data indicates a metric associated with providing IPTV service to the first group of subscriber premises, the second group of subscriber premises, or any combination thereof

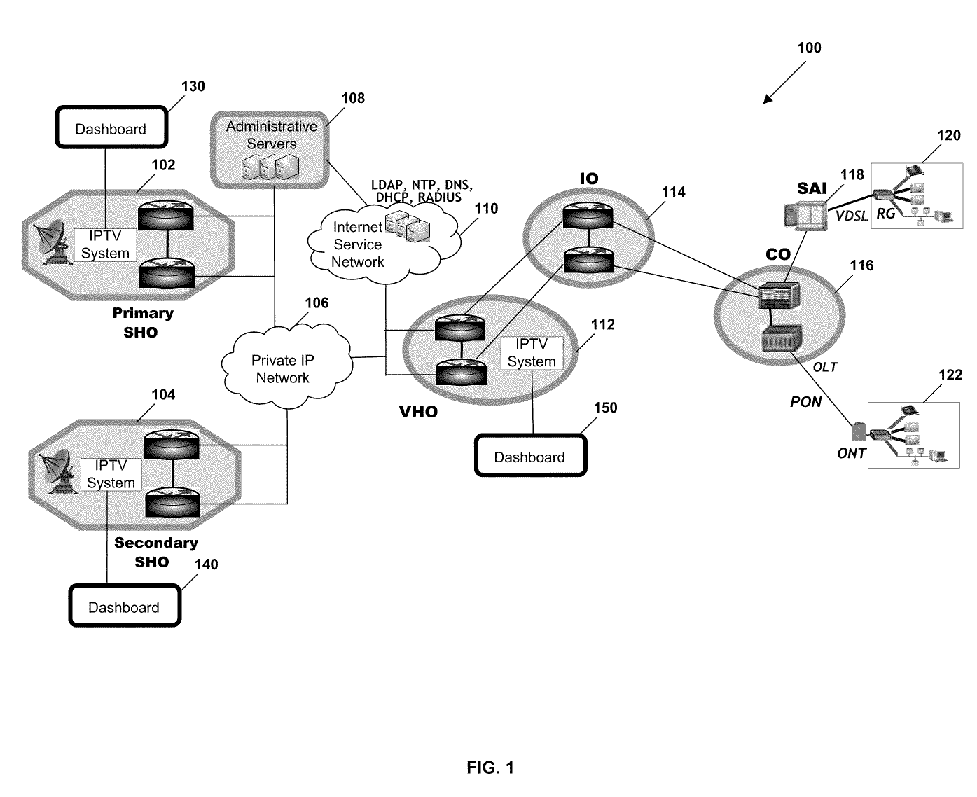

Referring to FIG. 1, a system to analyze Internet Protocol Television (IPTV) processes is illustrated and designated generally 100. System 100 includes a primary super head-end office, also referred to as a super hub office, (SHO) 102 and a secondary SHO 104 of a service provider network. The primary SHO 102 may include one or more routers, one or more switches, one or more servers, or any combination thereof In a particular embodiment, a server associated with the primary SHO 102 may be adapted to execute an IPTV system to provide IPTV services to one or more subscriber premises. The IPTV system of the primary SHO 102 may include a number of software applications related to providing IPTV services to subscriber premises. The primary SHO 102 may communicate with a dashboard 130. The dashboard 130 may be adapted to provide indicators relating to the performance of software applications or processes associated with the IPTV system of the primary SHO 102. In an illustrative embodiment, the primary SHO 102 may include servers, routers, switches, or any combination thereof, to provide multicast services to subscriber premises. For example, the primary SHO 102 may be adapted to provide multicast IPTV services to one or more subscriber premises. Additionally, the primary SHO 102 may include servers, routers, switches, or any combination thereof, to provide unicast services to subscriber premises. For example, the primary SHO 102 may be adapted to provide high-speed Internet services, Voice over Internet Protocol (VoIP) services, IPTV services, such as Instant Channel Change (ICC) services, or any combination thereof, to subscriber premises. Additionally, the primary SHO 102 may receive or acquire television content, movie content, advertisement content, other video content, or any combination thereof, from a broadcast service, such as a satellite acquisition system.

The primary SHO 102 may communicate with the secondary SHO 104 via a service provider network, such as a private Internet Protocol (IP) network 106. The secondary SHO 104 may include one or more routers, one or more switches, one or more servers, or any combination thereof In a particular embodiment, a server associated with the secondary SHO 104 may be adapted to execute an IPTV system to provide IPTV services to one or more subscriber premises. The IPTV system of the secondary SHO 104 may include a number of software applications related to providing IPTV services to subscriber premises. The secondary SHO 104 may communicate with a dashboard 140. The dashboard 140 may be adapted to provide indicators relating to the performance of software applications associated with the IPTV system of the primary SHO 102. In an illustrative embodiment, the secondary SHO 104 may include servers, routers, switches, or any combination thereof, to provide multicast services to subscriber premises. For example, the secondary SHO 104 may be adapted to provide multicast IPTV services to one or more subscriber premises. Additionally, the secondary SHO 104 may include servers, routers, switches, or any combination thereof, to provide unicast services to subscriber premises. For example, the secondary SHO 104 may be adapted to provide high-speed Internet services, Voice over Internet Protocol (VoIP) services, IPTV services, such as Instant Channel Change (ICC) services, or any combination thereof, to subscriber premises. Additionally, the secondary SHO 104 may receive or acquire television content, movie content, advertisement content, other video content, or any combination thereof, from a broadcast service, such as a satellite acquisition system. The secondary SHO 104 may provide services redundant to those of the primary SHO 102, a different set of services than the services provided by the primary SHO 102, or any combination thereof In addition, the secondary SHO 104 may serve the same subscriber premises as the primary SHO 102, different subscriber premises than the SHO 102, or any combination thereof Further, both the primary SHO 102 and the secondary SHO 104 may stream video content to subscriber premises.

In an illustrative, non-limiting embodiment, the secondary SHO 104 may serve as a disaster recovery SHO in the case of a failure of the primary SHO 102. To illustrate, if the primary SHO 102 becomes inoperable to provide IPTV services to subscriber premises, the secondary SHO 104 may be adapted to take over the functions previously assigned to the primary SHO 102.

In a particular embodiment, the system 100 includes administrative servers 108 and an Internet service network 110. The administrative servers 108 may be adapted to store and process information related to subscriber accounts. For example, the administrative servers 108 may include data related to subscriber billing, subscriber profiles, services authorized for particular subscribers, or any combination thereof The Internet service network 110 may be adapted to manage Internet Protocol traffic throughout the system 100. For example, the Internet service network 110 may be adapted to manage the assignment of Internet Protocol addresses throughout the system 100. The administrative servers 108 and the Internet service network 110 may communicate with other components of the system 100 via the private IP network 106. In addition, the administrative servers 108 and the Internet service network 110 may communicate via a direct communication link.

In a particular embodiment, the system 100 includes one or more video head-end offices, also referred to as a video hub offices (VHO), such as representative VHO 112. The video head-end office 112 may include one or more servers, one or more switches, one or more routers, or any combination thereof In a particular embodiment, a server associated with the VHO 112 may be adapted to execute an IPTV system to provide IPTV services to one or more subscriber premises. The IPTV system of the VHO 112 may include a number of software applications related to providing IPTV services to subscriber premises. The VHO 112 may communicate with a dashboard 150. The dashboard 150 may be adapted to provide indicators relating to the performance of software applications, processes or servers associated with the IPTV system of the VHO 112. In an illustrative embodiment, the VHO 112 may include servers, routers, switches, or any combination thereof, to provide multicast services to subscriber premises. For example, the VHO 112 may be adapted to provide multicast IPTV services to one or more subscriber premises. Additionally, the VHO 112 may include servers, routers, switches, or any combination thereof, to provide unicast services to subscriber premises. For example, the VHO 112 may be adapted to provide high-speed Internet services, Voice over Internet Protocol (VoIP) services, IPTV services, such as Instant Channel Change (ICC) services, or any combination thereof, to subscriber premises.

In an illustrative, non-limiting embodiment, the dashboards 130, 140, 150 may relate to a single graphical user interface that is adapted to provide information indicating the performance of software applications, network elements, processes, or any combination thereof, of the IPTV system associated with a corresponding component of the network 100. To illustrate, the dashboard 130 may indicate only the performance of software applications or processes executed by the IPTV system of the primary SHO 102 and the dashboard 140 may indicate only the performance of software applications or processes executed by the IPTV system of the secondary SHO 104. Alternatively, information related to the performance of software applications or processes associated with the IPTV systems of the primary SHO 102, the secondary SHO 104, the VHO 112, or any combination thereof, may be available via a common dashboard. Further, the data associated with the performance of applications related to the IPTV systems of each of the primary SHO 102, the secondary SHO 104, and the VHO 112 may be sent to a particular server corresponding to each of these components of the system 100 to produce a respective dashboard or to the same server to produce the common dashboard.

In a particular embodiment, the system 100 includes one or more intermediate offices (IO), such as representative IO 114. The TO 114 may include one or more servers, one or more switches, one or more routers, or any combination thereof In an illustrative embodiment, the TO 114 may include servers, routers, switches, or any combination thereof, to provide multicast services to subscriber premises. For example, the TO 114 may be adapted to provide multicast IPTV services to one or more subscriber premises. Additionally, the TO 114 may include servers, routers, switches, or any combination thereof, to provide unicast services to subscriber premises. For example, the TO 114 may be adapted to provide high-speed Internet services, Voice over Internet Protocol (VoIP) services, IPTV services, such as Instant Channel Change (ICC) services, or any combination thereof, to subscriber premises.

In a particular embodiment, the system 100 includes one or more central offices (CO), such as representative CO 116. The CO 116 may include one or more servers, one or more switches, one or more routers, or any combination thereof In an illustrative embodiment, the CO 116 may include servers, routers, switches, or any combination thereof, to provide multicast services to subscriber premises. For example, the CO 116 may be adapted to provide multicast IPTV services to one or more subscriber premises. Additionally, the CO 116 may include servers, routers, switches, or any combination thereof, to provide unicast services to subscriber premises. For example, the CO 116 may be adapted to provide high-speed Internet services, Voice over Internet Protocol (VoIP) services, IPTV services, such as Instant Channel Change (ICC) services, or any combination thereof, to subscriber premises.

The CO 116 may communicate with one or more service area interfaces (SAI), such as representative SAI 118. In an illustrative embodiment, the SAI 118 includes a digital subscriber line access multiplexer (DSLAM) to provide IPTV services to a first subscriber premises 120. The SAI 118 may communicate with one or more set-top box devices of the first subscriber premises 120 via customer premises equipment. In an illustrative, non-limiting embodiment, the customer premises equipment may include a router, a local area network device, a modem, such as a digital subscriber line (DSL) modem, a Cable Television system modem, a residential gateway, any other suitable device for facilitating communication between a set-top box device, a personal computer, a VoIP telephone, or any combination thereof, of the subscriber premises 120 and the SAI 118. Further, the SAI 118 may communicate with customer premises equipment of the subscriber premises 120 via a very high data rate subscriber loop (VDSL).

The CO 116 may also communicate with a second subscriber premises 122 via a fiber optic network. For example, the CO 116 may communicate with the second subscriber premises via a passive optical network (PON). The passive optical network may include an optical line terminal (OLT) and an optical network terminal (ONT).

The components of the system 100 may communicate with each other via any number of communications network connections. For example, the components of the system 100 may communicate with each other via a fiber optic network connection, via a gigabit Ethernet connection, such as a 1 gige connection or a 10 gige connection, or any combination thereof

In a particular embodiment, the primary SHO 102, the secondary SHO 104 or both may stream video content to a number of subscriber premises related to television shows, movies, live programming, pay-per-view programming, video on-demand programming, or any combination thereof

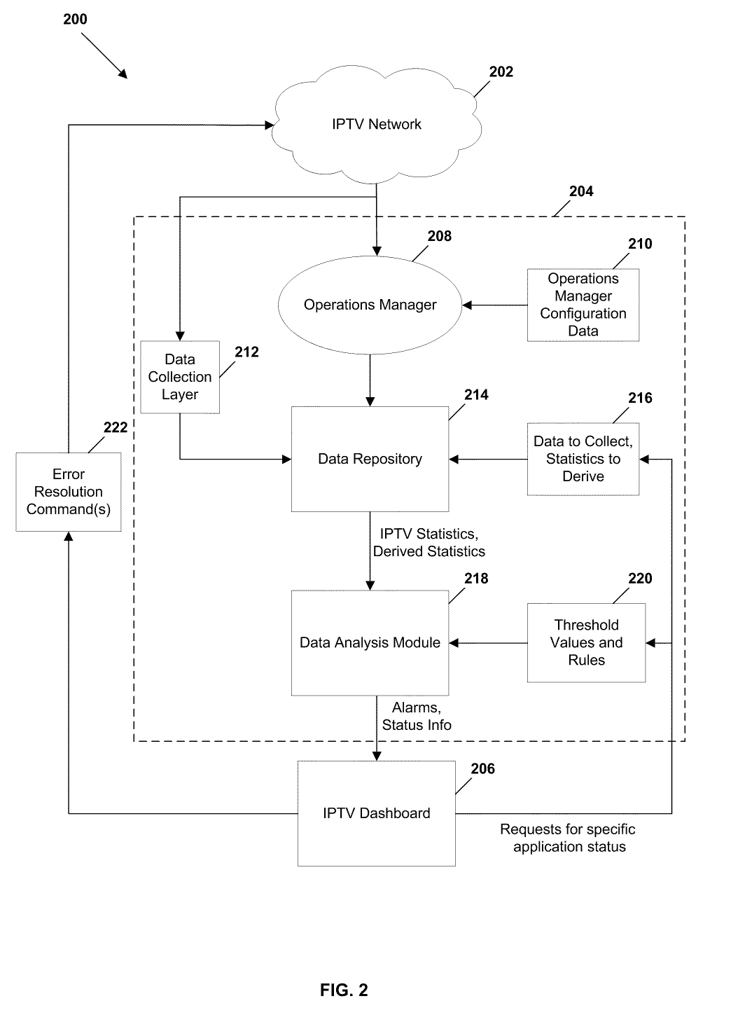

Referring to FIG. 2, a system to analyze Internet Protocol Television (IPTV) processes is illustrated and designated generally 200. System 200 includes an Internet Protocol Television (IPTV) network 202. The IPTV network 202 may include one or more servers, one or more switches, one or more routers, or any combination thereof, to provide IPTV services to one or more subscriber premises. In a particular embodiment, at least one of the servers of the IPTV network 202 includes an IPTV platform that includes one or more software applications to provide IPTV services to one or more subscriber premises.

System 200 also includes an IPTV application managing system 204. The IPTV application managing system 204 may be adapted to receive data from the IPTV network 202 and analyze the performance of applications, processes, servers, or other network elements of the IPTV network 202. The IPTV application managing system 204 may be adapted to send data to an IPTV dashboard 206, where the data indicates the performance of one or more applications associated with the IPTV network 202. The IPTV dashboard 206 may be related to a graphical user interface that includes a number of indicators, such as icons, graphs, charts, or any combination thereof, that indicate the performance of applications associated with the IPTV network 202.

In a particular embodiment, the IPTV application managing system 204 includes an operations manager 208. The operations manager 208 may be adapted to receive data from the IPTV network 202. In an illustrative embodiment, the operations manager may receive specified data from the servers of the IPTV network 202 related to IPTV software applications executed by the servers. The operations manager 208 may receive configuration data 210 related to the data that is received by the operations manager 208. The data received by the operations manager 208 may be associated with the configuration of the operations manager 208 at a particular time. The configuration data may be provided to the operations manager 208 from a service provider based on certain conditions occurring within the IPTV network 202. The operations manager 208 may receive the data in response to sending a request for the data or the data may periodically or automatically be sent from a particular server to the operations manager 208. In an illustrative, non-limiting embodiment, a server of the IPTV network 202 may send data to the operations manager 208 in response to a specific condition occurring at the server.

In a particular embodiment, the IPTV application managing system 204 includes a data collection layer 212. The data collection layer 212 receives data from the IPTV network 202. In an illustrative embodiment, the data collection layer 212 receives data from the IPTV network 202 that is different from the data received by the operations manager 208. The data collection layer 212 may be adapted to request data from servers of the IPTV network 208, the servers of the IPTV network 202 may be adapted to send specified data to the data collection layer 212, or any combination thereof The data received by the data collection layer 212 may be dependent on particular conditions within the IPTV network 202.

In a particular embodiment, the IPTV application managing system 204 includes a data repository 214. The data repository 214 may be adapted to receive data from the operations manager 208 and the data collection layer 212. The data received at the data repository 214 may relate to software applications executed by servers of the IPTV network 202. The data repository 214 may also be adapted to discard a portion of the data received from the operations manager 208 and the data collection layer 212, and send another portion of the data received from the operations manager 208 and the data collection layer 212 to a data analysis module 218. Further, the data repository 208 may be adapted to derive specified statistics from the received data. The data repository 214 may receive information 216 related to the data to be collected and statistics to be derived from the collected data. The information 216 may also relate to data that can be discarded by the data repository 214. The information 216 may be associated with requests received from the IPTV dashboard 206. The requests may be sent to the data repository 214 automatically based on a condition detected by the IPTV dashboard 206 or in response to a user input for particular data.

The data repository 214 sends the collected IPTV application statistics, data derived from the IPTV application statistics, or any combination thereof, to the data analysis module 218. The data analysis module 218 may be adapted to analyze the received data and determine a condition or status of one or more IPTV software applications based on the received data. For example, the data analysis module 218 may be adapted to determine if an error condition is occurring or is predicted to occur with respect to one or more IPTV software applications. The data analysis module 218 may perform an analysis of data received from the data repository 214 based on information related to threshold values and rules 220 associated with particular IPTV software applications. The threshold values and rules 220 may be provided by a service provider to indicate when IPTV service provided by the IPTV network 202 may be affected. For example, the threshold values and rules 220 may be established such that applying the threshold values and rules 220 to data received from the data repository 214 indicates a disruption or a predicted disruption in IPTV service, such as the interruption of one or more television shows, to one or more subscribers. In an illustrative embodiment, the data analysis module 218 may compare data received from the data repository 214 to particular threshold values, ranges, rules, or any combination thereof, to determine that a specified IPTV software application is being executed normally or that there is a problem with the specified IPTV software application. In addition, the data analysis module 218 may be adapted to determine that one or more IPTV software applications are operating within specified parameters. The threshold values and rules 220 may be related to information received from the IPTV dashboard 206. In an illustrative embodiment, the IPTV dashboard 206 may send information related to setting certain threshold values or establishing certain rules based on an input by a user of the IPTV dashboard 206. Further, the threshold values and rules 220 may be adjusted according to information sent from the IPTV dashboard 206 automatically based on a particular condition indicated by the IPTV dashboard 206.

In a particular embodiment, the data analysis module 218 may be adapted to provide alarms, status information, or any combination thereof, to the IPTV dashboard 206. The IPTV dashboard 206 may present the alarms and status information provided by the data analysis module 218 via a graphical user interface. The IPTV dashboard 206 may include indicators related to the execution of IPTV software applications on a number of servers associated with the IPTV network 202. The IPTV network servers may be associated with a super head-end office, one or more video head-end offices, other IPTV network components, or any combination thereof, of the IPTV network 202. Additionally, the IPTV dashboard 206 may be adapted to send one or more error resolution commands 222 to the IPTV network 202. For example, the IPTV dashboard 206 may receive data indicating an error associated with a particular IPTV application at a server of the IPTV network 202. In response to receiving the data, the IPTV dashboard 206 may be adapted to automatically determine actions that may be taken to correct the error. The IPTV dashboard 206 may generate one or more commands related to performing the appropriate corrective actions and send those commands to particular components of the IPTV network 202 for execution. The IPTV dashboard 206 may continue to send error resolution commands 222 to the IPTV network 202 until the error has been resolved or the IPTV dashboard 206 may be adapted to send a request to a service provider technician relating to the error.

Further, the IPTV dashboard 206 may be adapted to automatically send requests for data related to specific IPTV software applications to the data repository 214 and the data analysis module 218. The requests may be associated with certain error conditions or certain predicted error conditions indicated by data received by the IPTV dashboard 206. In addition, a service provider representative operating the IPTV dashboard 206 may send a request for specified data to the data repository 214, the data analysis module 218, or any combination thereof, by entering an input via the IPTV dashboard 206.

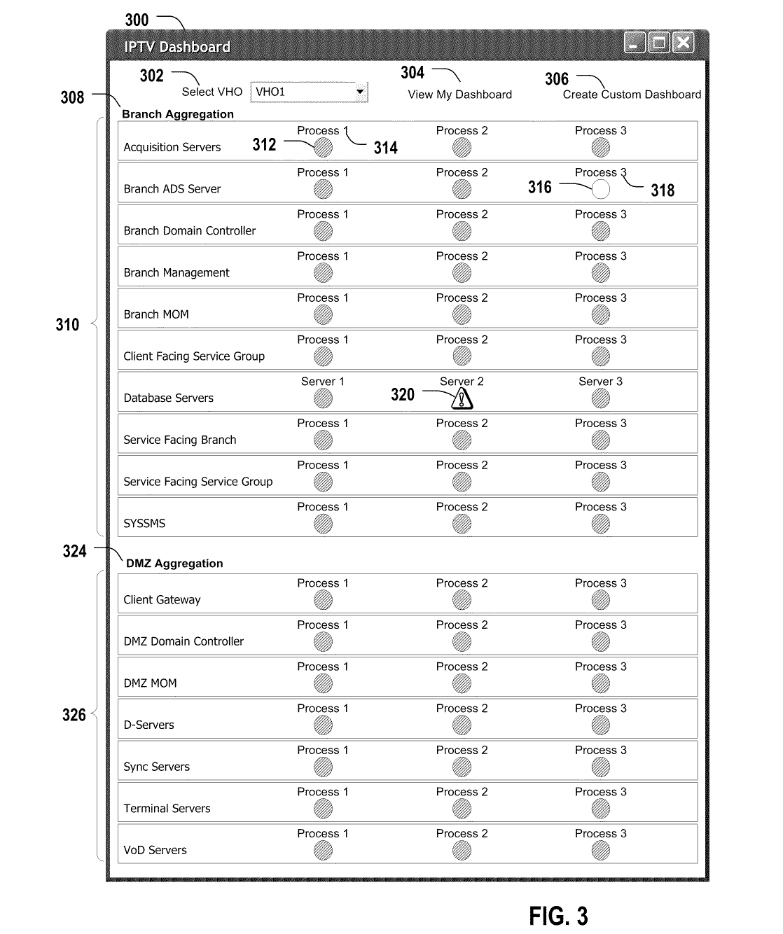

FIG. 3 depicts a particular embodiment of a graphical user interface (GUI) for monitoring an Internet Protocol Television (IPTV) network. The GUI is generally referenced as 300. The GUI 300 includes a plurality of graphical elements which provide a graphical representation of operational information related to the IPTV network. For example, the operational information may be related to the operation of particular processes, software applications, or network elements (e.g., servers, routers, switches, etc.).

In a particular embodiment, the GUI 300 may include a user selectable element that enables a user to select a particular predefined dashboard display. For example, the GUI 300 includes an input element 302 that allows the user to select a particular video head-end office (VHO) for which information is to be displayed. In various illustrative embodiments, input element 302 may allow the user to select from among other predefined dashboard displays. For example, a user may be able to see an overview dashboard display that includes summary information related to the entire IPTV network. In another example, the user may be able to see a dashboard display related to a particular region; a particular type of server; a particular type of software application or process; any other grouping or division of network elements, software applications, or processes within the IPTV network; or any combination thereof Additionally, the GUI 300 may include an input selection element 306 that enables the user to create a custom dashboard display. A custom dashboard display may provide information of particular interest to the user. For example, a user with responsibilities for a particular set of servers may configure a custom dashboard display that includes operational information for those servers. Similarly, a user may configure a custom dashboard display to include any particular set of processes, software applications, or network elements that are of interest to the user. Additionally, a custom dashboard display may include links to additional custom dashboard displays or predefined dashboard displays to allow the user to drill down to additional information. The user's custom dashboard display may be accessed via a “View My Dashboard” user selectable element 304.

The particular embodiment displayed in FIG. 3 includes information related to a VHO designated as “VHO 1.” Operational information related to VHO 1 is displayed in two sections: a first section 310 that includes information related to a branch aggregation 308, and a second section 326 that includes information related to a DMZ aggregation 324. Thus, the first section 310 includes operational information aggregated at the branch level. To illustrate, the first section 310 includes a first graphical element 312 related to a first process 314 implemented at acquisitions servers. In a particular embodiment, when the first graphical element 312 indicates that no conditions meriting further attention are occurring (for example, when the first graphical element 312 is green), this means that no instance of the first process on any acquisition server under the branch level aggregation has a condition that merits further attention. To illustrate, no instance of the first process 314 is running above a threshold or alarm level.

As a further illustration, the first section 310 also includes a second graphical element 316 associated with a third process 318 implemented at one or more branch ADS servers. The second graphical element 316 is different than the first graphical element 312 to indicate that a condition meriting further attention is present. For example, the second graphical element 316 may have a red color (indicated by the lack of cross-hatching) and the first graphical element 312 may have a green color (indicated by the cross-hatching). In another example, the second graphical element 316 may be flashing and the first graphical element 312 may be steady, or visa versa. The second graphical element 316 may be changed to indicate that a condition meriting further attention is present when one or more threshold values or alarm levels are exceeded. For example, a threshold value or alarm level may be associated with a level of usage of a particular process or network element. In a particular illustrative embodiment, custom threshold values or alarm levels may be associated with a custom dashboard display.

In a particular embodiment, a graphical display element may indicate that a condition meriting further attention is present when the graphical display element has a particular shape. For example, a third graphical element 320 may indicate that a condition meriting further attention is present at a second server of the database servers. In an illustrative embodiment, a color change of the graphical display element may occur when a particular threshold value is exceeded, and a shape change may occur when an alarm level is exceeded.

In a particular embodiment, a user of the GUI 300 may be able to drill down to additional information by selecting a graphical display element associated with the desired information. For example, if the user desires to see what process of the second server of the database servers is of concern, the user may select the third graphical element 320 to modify the dashboard display to include information about processes executing at the second server.

In a particular embodiment, the GUI 300 may also be adapted to receive input to correct a problem identified via the GUI 300. For example, the user may select the second graphical element 316 to view a context menu. The context menu may include user selectable options to generate a command to the branch ADS server that has a problem indicated by the second graphical element 316. For example, the user may be able to automatically generate a command to the branch ADS server that has a problem with the execution of the third process 318 to restart the process. In another example, the context menu may enable the user to send a command to a different network element to correct a detected problem. For example, the user may be able to automatically generate a command to shift the third process 318 to a different server via load balancing. The user may generate and send the command by selecting from a predefined list of commands or by accessing a text editor to create a custom command or script. The user may also be able to either drill down to more information about the specific server that has the problem to generate the command, or the command may be generated from an aggregate display, such as the GUI 300. When the command is generated at the aggregate display, the command may automatically be routed to the server that is experiencing the problem.

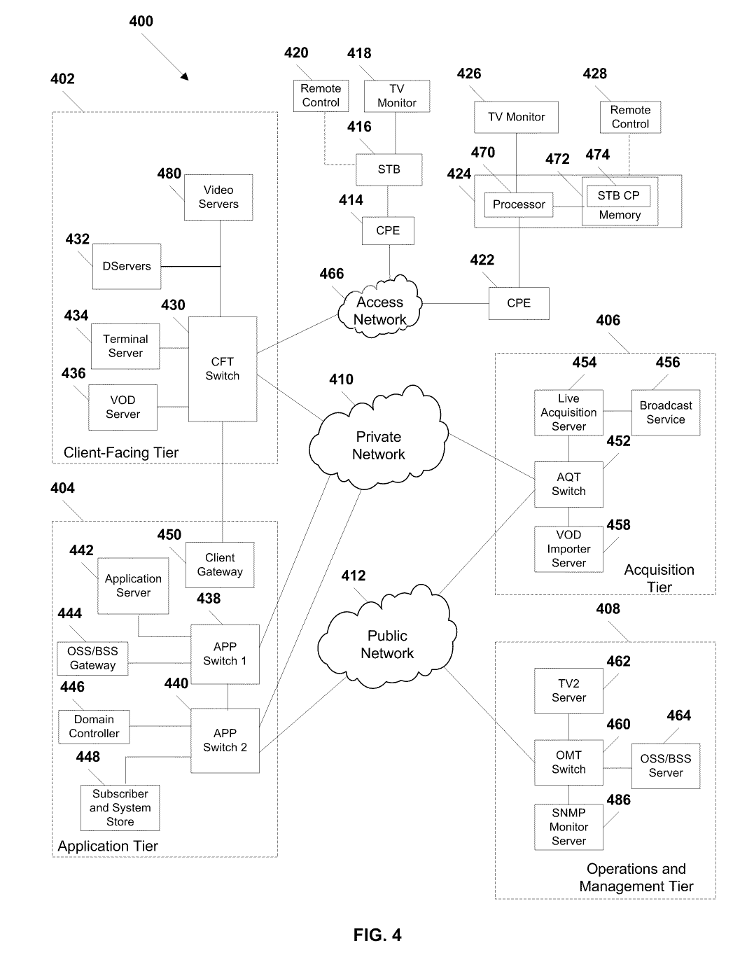

Referring to FIG. 4, an illustrative embodiment of an Internet Protocol Television (IPTV) system is illustrated and is generally designated 400. As shown, the system 400 can include a client facing tier 402, an application tier 404, an acquisition tier 406, and an operations and management tier 408. Each tier 402, 404, 406, 408 is coupled to a private network 410; to a public network 412, such as the Internet; or to both the private network 410 and the public network 412. For example, the client-facing tier 402 can be coupled to the private network 410. Further, the application tier 404 can be coupled to the private network 410 and to the public network 412. The acquisition tier 406 can also be coupled to the private network 410 and to the public network 412. Additionally, the operations and management tier 408 can be coupled to the public network 412.

As illustrated in FIG. 4, the various tiers 402, 404, 406, 408 communicate with each other via the private network 410 and the public network 412. For instance, the client-facing tier 402 can communicate with the application tier 404 and the acquisition tier 406 via the private network 410. The application tier 404 can communicate with the acquisition tier 406 via the private network 410. Further, the application tier 404 can communicate with the acquisition tier 406 and the operations and management tier 408 via the public network 412. Moreover, the acquisition tier 406 can communicate with the operations and management tier 408 via the public network 412. In a particular embodiment, elements of the application tier 404, including, but not limited to, a client gateway 450, can communicate directly with the client-facing tier 402.

The client-facing tier 402 can communicate with user equipment via an access network 466, such as an Internet Protocol Television (IPTV) access network. In an illustrative embodiment, customer premises equipment (CPE) 414, 422 can be coupled to a local switch, router, or other device of the access network 466. The client-facing tier 402 can communicate with a first representative set-top box device 416 via the first CPE 414 and with a second representative set-top box device 424 via the second CPE 422. In another illustrative embodiment, the client-facing tier 402 may also communicate with the access network 466 via a wireless connection, such as a Wi-Fi connection, a Wi-Max connection, or a Bluetooth connection. Further, the client-facing tier 402 may communicate with other devices, such as a cell phone, a laptop computer, or a gaming system, via the access network 466.

In a particular embodiment, the first representative set-top box device 416 and the first CPE 414 can be located at a first customer premises, and the second representative set-top box device 424 and the second CPE 422 can be located at a second customer premises. In another particular embodiment, the first representative set-top box device 416 and the second representative set-top box device 424 can be located at a single customer premises, both coupled to one of the CPE 414, 422. The CPE 414, 422 can include routers, local area network devices, modems, such as digital subscriber line (DSL) modems, any other suitable devices for facilitating communication between a set-top box device and the access network 466, or any combination thereof

In an exemplary embodiment, the client-facing tier 402 can be coupled to the CPE 414, 422 via fiber optic cables. In another exemplary embodiment, the CPE 414, 422 can be digital subscriber line (DSL) modems that are coupled to one or more network nodes via twisted pairs, and the client-facing tier 402 can be coupled to the network nodes via fiber-optic cables. Each set-top box device 416, 424 can process data received via the access network 466, via an IPTV software platform, such as Microsoft® TV IPTV Edition.

The first set-top box device 416 can be coupled to a first external display device, such as a first television monitor 418, and the second set-top box device 424 can be coupled to a second external display device, such as a second television monitor 426. Moreover, the first set-top box device 416 can communicate with a first remote control 420, and the second set-top box device 424 can communicate with a second remote control 428. The set-top box devices 416, 424 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 416, 424 can receive data, video, or any combination thereof, from the client-facing tier 402 via the access network 466 and render or display the data, video, or any combination thereof, at the display device 418, 426 to which it is coupled. In an illustrative embodiment, the set-top box devices 416, 424 can include tuners that receive and decode television programming signals or packet streams for transmission to the display devices 418, 426. Further, the set-top box devices 416, 424 can include a STB processor 470 and a STB memory device 472 that is accessible to the STB processor 470. In one embodiment, a computer program, such as the STB computer program 474, can be embedded within the STB memory device 472.

In an illustrative embodiment, the client-facing tier 402 can include a client-facing tier (CFT) switch 430 that manages communication between the client-facing tier 402 and the access network 466 and between the client-facing tier 402 and the private network 410. As illustrated, the CFT switch 430 is coupled to one or more data servers, such as D-servers 432, that store, format, encode, replicate, or otherwise manipulate or prepare video content for communication from the client-facing tier 402 to the set-top box devices 416, 424. The CFT switch 430 can also be coupled to a terminal server 434 that provides terminal devices with a point of connection to the IPTV system 400 via the client-facing tier 402. In a particular embodiment, the CFT switch 430 can be coupled to a video-on-demand (VOD) server 436 that stores or provides VOD content imported by the IPTV system 400. Further, the CFT switch 430 is coupled to one or more video servers 480 that receive video content and transmit the content to the set-top boxes 416, 424 via the access network 466.

In an illustrative embodiment, the client-facing tier 402 can communicate with a large number of set-top boxes, such as the representative set-top boxes 416, 424, over a wide geographic area, such as a metropolitan area, a viewing area, a statewide area, a regional area, a nationwide area or any other suitable geographic area, market area, or subscriber or customer group that can be supported by networking the client-facing tier 402 to numerous set-top box devices. In a particular embodiment, the CFT switch 430, or any portion thereof, can include a multicast router or switch that communicates with multiple set-top box devices via a multicast-enabled network.

As illustrated in FIG. 4, the application tier 404 can communicate with both the private network 410 and the public network 412. The application tier 404 can include a first application tier (APP) switch 438 and a second APP switch 440. In a particular embodiment, the first APP switch 438 can be coupled to the second APP switch 440. The first APP switch 438 can be coupled to an application server 442 and to an OSS/BSS gateway 444. In a particular embodiment, the application server 442 can provide applications to the set-top box devices 416, 424 via the access network 466, which enable the set-top box devices 416, 424 to provide functions, such as interactive program guides, video gaming, display, messaging, processing of VOD material and other IPTV content, etc. In an illustrative embodiment, the application server 442 can provide location information to the set-top box devices 416, 424. In a particular embodiment, the OSS/BSS gateway 444 includes operation systems and support (OSS) data, as well as billing systems and support (BSS) data. In one embodiment, the OSS/BSS gateway 444 can provide or restrict access to an OSS/BSS server 464 that stores operations and billing systems data.

The second APP switch 440 can be coupled to a domain controller 446 that provides Internet access, for example, to users at their computers 468 via the public network 412. For example, the domain controller 446 can provide remote Internet access to IPTV account information, e-mail, personalized Internet services, or other online services via the public network 412. In addition, the second APP switch 440 can be coupled to a subscriber and system store 448 that includes account information, such as account information that is associated with users who access the IPTV system 400 via the private network 410 or the public network 412. In an illustrative embodiment, the subscriber and system store 448 can store subscriber or customer data and create subscriber or customer profiles that are associated with IP addresses, stock-keeping unit (SKU) numbers, other identifiers, or any combination thereof, of corresponding set-top box devices 416, 424. In another illustrative embodiment, the subscriber and system store 448 can store data associated with capabilities of set-top box devices associated with particular customers.

In a particular embodiment, the application tier 404 can include a client gateway 450 that communicates data directly to the client-facing tier 402. In this embodiment, the client gateway 450 can be coupled directly to the CFT switch 430. The client gateway 450 can provide user access to the private network 410 and the tiers coupled thereto. In an illustrative embodiment, the set-top box devices 416, 424 can access the IPTV system 400 via the access network 466, using information received from the client gateway 450. User devices can access the client gateway 450 via the access network 466, and the client gateway 450 can allow such devices to access the private network 410 once the devices are authenticated or verified. Similarly, the client gateway 450 can prevent unauthorized devices, such as hacker computers or stolen set-top box devices from accessing the private network 410, by denying access to these devices beyond the access network 466.

For example, when the first representative set-top box device 416 accesses the client-facing tier 402 via the access network 466, the client gateway 450 can verify subscriber information by communicating with the subscriber and system store 448 via the private network 410. Further, the client gateway 450 can verify billing information and status by communicating with the OSS/BSS gateway 444 via the private network 410. In one embodiment, the OSS/BSS gateway 444 can transmit a query via the public network 412 to the OSS/BSS server 464. After the client gateway 450 confirms subscriber and/or billing information, the client gateway 450 can allow the set-top box device 416 to access IPTV content and VOD content at the client-facing tier 402. If the client gateway 450 cannot verify subscriber information for the set-top box device 416, e.g., because it is connected to an unauthorized twisted pair, the client gateway 450 can block transmissions to and from the set-top box device 416 beyond the access network 466. The client gateway 450 can also block transmissions to and from the set-top box device 416 beyond the access network 466 because of authentication and authorization problems.

As indicated in FIG. 4, the acquisition tier 406 includes an acquisition tier (AQT) switch 452 that communicates with the private network 410. The AQT switch 452 can also communicate with the operations and management tier 408 via the public network 412. In a particular embodiment, the AQT switch 452 can be coupled to a live acquisition server 454 that receives or acquires television content, movie content, advertisement content, other video content, or any combination thereof, from a broadcast service 456, such as a satellite acquisition system or satellite head-end office. In a particular embodiment, the live acquisition server 454 can transmit content to the AQT switch 452, and the AQT switch 452 can transmit the content to the CFT switch 430 via the private network 410 or the public network 412.

In an illustrative embodiment, content can be transmitted to the D-servers 432, where it can be formatted, stored, replicated, or otherwise manipulated and prepared for communication from the video server(s) 480 to the set-top box devices 416, 424. The CFT switch 430 can receive content from the video server(s) 480 and communicate the content to the CPE 414, 422 via the access network 466. The set-top box devices 416, 424 can receive the content via the CPE 414, 422, and can transmit the content to the television monitors 418, 426. In an illustrative embodiment, video or audio portions of the content can be streamed to the set-top box devices 416, 424.

Further, the AQT switch 452 can be coupled to a video-on-demand (VOD) importer server 458 that receives and stores television or movie content received at the acquisition tier 406 and communicates the stored content to the VOD server 436 at the client-facing tier 402 via the private network 410. Additionally, at the acquisition tier 406, the VOD importer server 458 can receive content from one or more VOD sources outside the IPTV system 400, such as movie studios and programmers of non-live content. The VOD importer server 458 can transmit the VOD content to the AQT switch 452, and the AQT switch 452, in turn, can communicate the material to the CFT switch 430 via the private network 410. The VOD content can be stored at one or more servers, such as the VOD server 436.

When users issue requests for VOD content via the set-top box devices 416, 424, the requests can be transmitted over the access network 466 to the VOD server 436, via the CFT switch 430. Upon receiving such requests, the VOD server 436 can retrieve the requested VOD content and transmit the content to the set-top box devices 416, 424 across the access network 466, via the CFT switch 430. The set-top box devices 416, 424 can transmit the VOD content to the television monitors 418, 426. In an illustrative embodiment, video or audio portions of VOD content can be streamed to the set-top box devices 416, 424.

FIG. 4 further illustrates that the operations and management tier 408 can include an operations and management tier (OMT) switch 460 that conducts communication between the operations and management tier 408 and the public network 412. In the embodiment illustrated by FIG. 4, the OMT switch 460 is coupled to a TV2 server 462. Additionally, the OMT switch 460 can be coupled to an OSS/BSS server 464 and to a simple network management protocol (SNMP) monitor 486 that monitors network devices within or coupled to the IPTV system 400. In a particular embodiment, the OMT switch 460 can communicate with the AQT switch 452 via the public network 412.

In an illustrative embodiment, the live acquisition server 454 can transmit content to the AQT switch 452, and the AQT switch 452, in turn, can transmit the content to the OMT switch 460 via the public network 412. In this embodiment, the OMT switch 460 can transmit the content to the TV2 server 462 for display to users accessing the user interface at the TV2 server 462, such as via a personal computer coupled to the public network 412.

In other embodiments, the CFT Switch 430, the APP Switch 1 438, the APP Switch 2 440, the OMT Switch 460, and the AQT Switch 452 may be routers or another type of network device.

A dashboard display, such as the GUI 300 discussed with reference to FIG. 3, may include information related to any one or more of the servers or other network elements depicted in FIG. 4. Additionally, the dashboard display may include operational information related to any process or software application implemented by any one or more of the servers or other network elements depicted in FIG. 4.

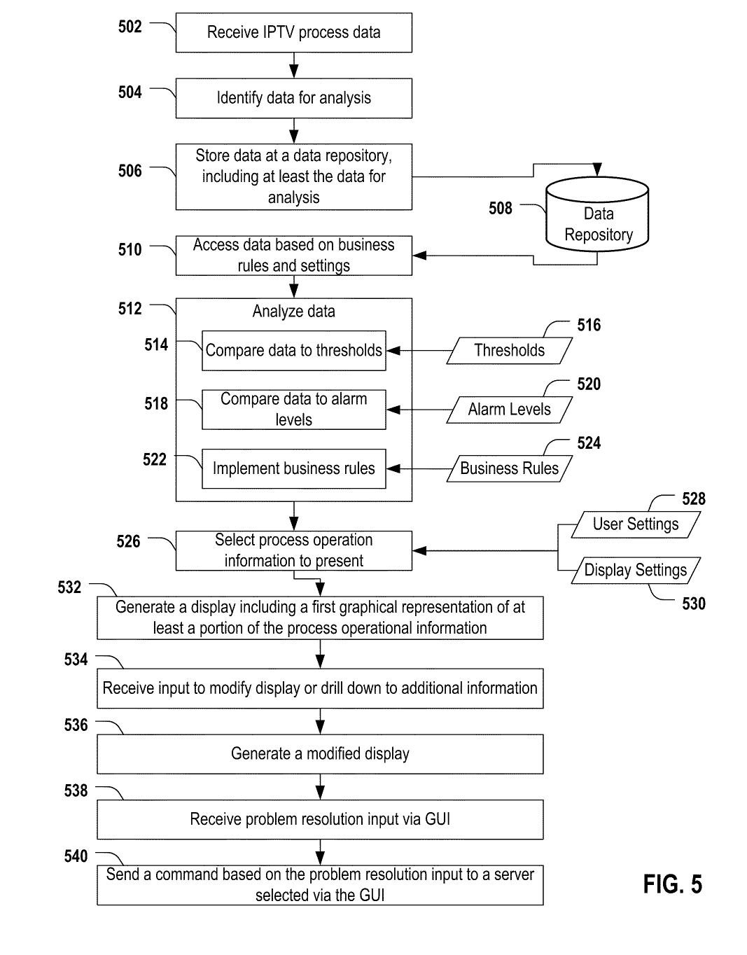

FIG. 5 depicts a particular embodiment of a method of monitoring an Internet Protocol Television (IPTV) network. The method includes, at 502, receiving IPTV process data. The IPTV process data may include information about a plurality of processes executing at a plurality of servers of an IPTV distribution network. For example, the processes may include individual data transactions related to acquiring content, processing content, distributing content, managing subscriber information, any other activity performed by the IPTV network, or any combination thereof To illustrate, a process may be related to authenticating a digital rights management (DRM) key associated with particular content. The process of authenticating the DRM key may include a number of sub-steps, such as a process for accessing the DRM key, a process to implement a web application to send the key to an authentication server, and so forth. In a particular embodiment, the IPTV process data may include data about the operation of the overall DRM key authentication process for particular content at a particular server of the IPTV network. In another particular embodiment, the IPTV process data may include information about the operation of each of the individual sub-steps for authenticating the DRM key. Likewise, other processes implemented by servers of the IPTV network may include one or more sub-steps and the IPTV process data may include information related to the overall process, information related to the sub-steps, or any combination thereof Further, the IPTV process data may include information related to one or more operation of one or more software applications implemented by the IPTV network. Additionally, the IPTV process data may include information related to the operation of one or more servers or other network elements of the IPTV network.

In a particular embodiment, the method may include, at 504, identifying which data of the IPTV process should be analyzed. The data identified to be analyzed may include data related to particularly significant processes, to process or transaction errors, to predefined settings, or to any combination thereof The method may also include, at 506, storing at least the data to be analyzed at a data repository 508.

The method includes, at 510, accessing data from the data repository 508 for analysis. In a particular embodiment, the data to be accessed for analysis may be determined based on particular business rules or configuration settings.

The method also includes, at 512, analyzing the IPTV process data to determine process operational information. The process operational information is descriptive of the operation of at least one of the plurality of processes, software applications or network elements of the IPTV network. In an illustrative embodiment, analyzing the data may include, at 514, comparing the data to threshold values 516. The threshold values 516 may be predetermined values that are associated with particular operational characteristics. For example, if a particular threshold is met, it may indicate that a process associated with the particular threshold is at a certain percentage of capacity. To illustrate, a first threshold may be met when a particular process is at 50% of capacity. Similarly, a second threshold may be met when the process is at 75% of capacity. In another example, a particular threshold may be associated with an operational capacity of a particular server. Thus, if the particular server has a capacity to substantially simultaneously perform a limited number of processes or a limited number of instances of a particular process, a threshold may indicate what percentage of the capacity the server is using.

In an illustrative embodiment, analyzing the data may include, at 518, comparing the data to alarm levels 520. When an alarm level is reached, an alarm may be triggered. Depending on the configuration of the system, triggering the alarm may cause a graphical or audible alarm to be presented to one or more users via a dashboard display or other display. In a particular illustrative embodiment, an indicator in a graphical user interface (GUI) may turn red or flash when the alarm is triggered. In another particular embodiment, a message may be sent when the alarm is triggered. For example, an email message, text message, automated voice call, any other type of message, or any combination thereof, may be sent indicating that the alarm has been triggered.

In an illustrative embodiment, analyzing the data may include, at 522, implementing one or more business rules 524. In a particular embodiment, the business rules 524 may be used to process the data before comparison to the thresholds 516 or alarm levels 520. For example, the business rules 524 may indicate a manner of aggregating the IPTV process data before it is compared to a particular threshold. To illustrate, a particular threshold may be associated with the operational capacity of two or more servers that operate in parallel (e.g., to balance load between the servers). The business rules 524 may indicate that the process data related to each of the servers is to be aggregated before comparison to the particular threshold. In another example, the business rules 524 may include logic (e.g., Boolean logic) for determining operational information based on the process data. To illustrate, a single indicator in a GUI may be associated with all of the processes implemented at a particular server or at a set of servers (e.g., at a VHO). The logic may indicate that each of the processes is to be compared to a threshold and if at least one of the processes exceeds the threshold to which it is compared, the indicator associated with all of the processes should be changed to indicate that at least one threshold is exceeded. In another example, the GUI may include a display element associated with a particular server. As long as the server is not exceeding any threshold, then the display element may be green (indicating that no condition meriting attention is present at the server). However, when any process of the server exceeds its associated threshold, the display element may turn red (indicating that a condition meriting attention is present at the server).

The method also include, at 526, selecting process information to present to a user via the GUI. The process information to present may be selected based on one or more user settings 528, one or more display settings 530, or any combination thereof In an illustrative embodiment, the display settings 530 may include default settings associated with one or more predefined display screens. For example, a predefined display screen may be associated with a particular VHO. A predefined VHO display screen may include information associated with one or more servers at the VHO. Likewise, a predefined screen may be associated with one or more servers. A predefined server display screen may include information associated with one or more processes implemented by the server. In a particular illustrative embodiment, the predefined server display screen may be linked to the predefined VHO display screen of the particular VHO where the server resides. Linking the display screens in this manner may allow a user to “drill down” from a VHO display screen to a particular server at the VHO to gather more information about a condition at the server. The user settings 528 may be associated with custom dashboard displays. For example, a user may store user settings 528 to define a dashboard display that is of particular interest to the user.

The method also includes, at 532, generating a display including a first graphical representation of at least a portion of the process operational information. The first graphical representation of the process operational information may include, for example, a graphical, numerical or color-coded display element. The graphical representation may allow a user to quickly determine whether a particular process, server, VHO, region, or any other portion of the IPTV network represented by the graphical representation, has a condition that merits attention. In an illustrative embodiment, the graphical representation may be presented along with one or more other graphical representations of other process operational information via a dashboard display. The dashboard display may provide a summary of operation information at a particular level, such as at a single server, within a service area, within a geographic area, at a single VHO, or any combination thereof.

The method also includes, at 534, receiving input to modify the display or to drill down to additional information, and, at 536, generating a modified display. The display may be modified to drill down to a desired level of granularity. For example, a first display may include information related to the entire IPTV network. At the first display a user may select a graphical element associated with a particular VHO, and, in response to the selection, the display may be modified to include only information about the particular VHO. Similarly, the user may drill down from the VHO view to a view associated with a particular server, from a server view to a view associated with a particular process, from a process view to a view associated with a particular sub-step of the process, or any combination thereof Additionally, users may configure views that suit their particular needs. For example, a user whose job particularly relates to video distribution servers may configure a view that only includes information about video distribution servers. Likewise, any desired combination of operation information desired by a user may be presented via a user specific display configuration.

The method also includes, at 538, receiving problem resolution input via the GUI. Problem resolution input may include input to select a particular network element (such as a server) or a particular process. Additionally, the problem resolution input may include input to generate a command to be sent to the particular network element or process. In an illustrative embodiment, the command may be directed to resolving a particular problem at the network element or with the process. For example, a graphical representation associated with a particular process or network element may indicate a condition meriting further attention. A user may select the graphical representation associated with the particular process or network element and generate a command to send to the process or network element to resolve the condition. In a particular illustrative embodiment, the command may be generated automatically based on automated error correction processes. In another particular embodiment, the command may be selected from a plurality of predefined error correction commands. For example, the command may be selected from a pull down context menu presented when the graphical representation is selected. In another particular embodiment, the command may be input by the user in a text editor window presented when the graphical representation is selected. The method may also include, at 540, sending the command to the process or network element.

Embodiments disclosed herein provide an IPTV dashboard display to monitor an IPTV network. The IPTV dashboard includes a proactive monitoring system that can help predict failures before they occur. To predict failures, specific processes may be monitored and specific thresholds may be set based upon the size of a Service Group, a number of IPTV system devices, customers assigned to each Service Group, other factors, or any combination thereof In addition, the IPTV dashboard may allow new processes to be added or old processes to be removed dynamically.

Further embodiments disclose IPTV dashboard business rules, algorithms, and configuration. By way of example, the rules, algorithms, and configuration may be related to what specific data to collect, the specific threshold values to apply to each piece of collected data, and what action to take when a threshold violation has occurred. This includes, but is not limited to, the specific statistics retrieved directly from the source system (e.g., a Microsoft Operations Manager (MOM) server), as well as, any specifically defined derived statistics, and the configuration of the source system and back-end processes needed to gather and consolidate the source data prior to access by the IPTV dashboard.

Examples of processes that may be monitored include, but are not limited to: CPU utilization, for example:
CPU utilization may be monitored and benchmarked to ensure that a non-recoverable threshold is not crossed.
   Specific Application events, for example:
Aserver Encoder restarts can be monitored and used to determine whether external feeds are having issues;
Dserver service restarts can be monitored and used to indicate whether multicast streams are having issues;
RDP service restarts can be monitored and used to indicate if external apps or connection levels have been exceeded;
Sync Server service restarts can be monitored and used to indicate if NLB's are having issues or other network problems;
IIS service can be monitored and used to indicate miss configuration or memory use within IIS has been exceeded due to too much traffic.
   IIS logs can be monitored and used to indicate if specific sub-applications within an IPTV system are having issues or exceeded their capacity, these are typically logged as errors, for example:
Bootstrap calls,
Get Client Rights calls,
DVR scheduler calls,
DVR start/stop record calls,
Discovery calls,
Account creation calls,
Device creation calls, and
Others as determined are needed.
   IIS logs may be monitored and used to determine the amount of time a web call takes. The duration of web calls indicates issues with other sub-processes within the IPTV system, including, for example:
Bootstrap calls,
Get Client Rights calls,
DVR scheduler calls,
DVR start/stop record calls,
Discovery calls,
Account creation calls,
Device creation calls, and
Others as determined are needed.
   NT services can be monitored to determine whether individual services are not running as they should or whether too many services are running.
   Trace sink log files can be used to determine whether there are IP filter issues and/or used to determine whether there are blocked web call issues.
   Network connections, the number of connections and the used bandwidth can be monitored, including connections at, for example:
Dservers,
Terminal servers,
Aservers,
CGATE servers,
CFWA servers, and
SQL server/Cluster connections.
   A SQL server can be monitored, including, for example execution time of specific Stored Procedures, and the number of times a Stored Procedure is being called.
   STB status can be monitored, including, for example the number of STB's active on the network, the number of times a STB requests Boot Authentication, and the version of STB client loaded.

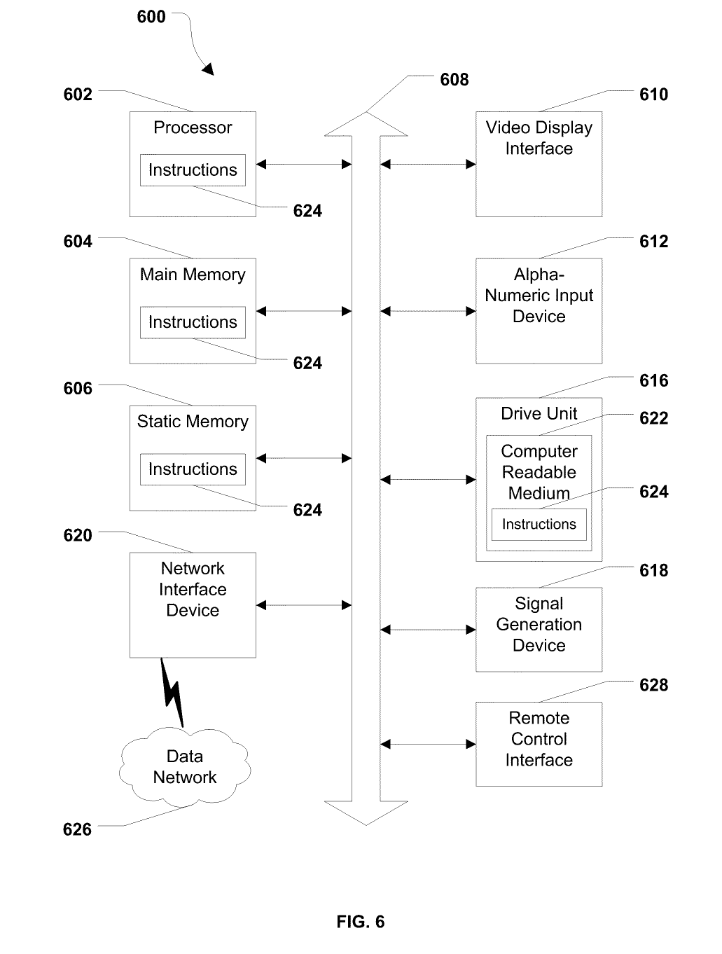

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606, that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse or remote control. The computer system 600 can also include a disk drive unit 616, a signal generation device 618, such as a speaker, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for wireless communications networks (e.g., Wi-Fi, Wi-Max, Bluetooth and so forth), Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of displaying data on an operational dashboard of an Internet Protocol Television (IPTV) system, the method comprising:
receiving IPTV process data, wherein the IPTV process data includes information about a plurality of processes of a plurality of servers of an IPTV distribution network;
analyzing the IPTV process data to determine operational information, wherein the operational information is descriptive of operation of at least one first process of the plurality of processes and operation of at least one second process of the plurality of processes; and
generating a display based on the operational information, wherein the display comprises an aggregate display element representing the operation of the at least one first process and the operation of the at least one second process.

2. The method of claim 1, further comprising:
receiving input via a graphical user interface to modify the display; and
generating a modified display.

3. The method of claim 1, further comprising:
receiving input via a graphical user interface to provide additional process operational information related to the first process; and
generating a display including a display element representing the operation of only the at least one first process.

4. The method of claim 1, further comprising:
receiving input via a graphical user interface to provide additional process operational information; and
generating a display including a second aggregate display element representing the operation of the at least a first process, the operation of the at least a second process and operation of at least one third process of the plurality of processes.

5. The method of claim 1, further comprising:
receiving problem resolution input via a graphical user interface, wherein the problem resolution input is related to the at least one first process; and
sending a command to a server associated with the at least one first process based on the problem resolution input.

6. The method of claim 5, wherein receiving the problem resolution input comprises receiving input selecting problem resolution command from a list of problem resolution commands related to the at least one first process.

7. The method of claim 5, further comprising receiving input selecting the aggregate display element, and generating a context menu including problem resolution commands related to the at least one first process and the at least one second based at least partially on the process operational information.

8. A graphical user interface (GUI) for monitoring an Internet Protocol Television (IPTV) network, the GUI comprising:
an aggregate graphical display element including a graphical representation of process operational information of a first process at a first server of an IPTV network and of process operational information of a second process at the first server of the IPTV network.

9. The GUI of claim 8, further comprising at least one second graphical display element including a graphical representation of process operational information associated with a third process at a second server of the IPTV network.

10. The GUI of claim 9, wherein the first server and the second server are located at different video head-end offices.

11. The GUI of claim 9, wherein the at least one third graphical display element comprises aggregate information associated with at least the first process, the second process and the third process.

12. The GUI of claim 8, wherein a color of the aggregate graphical display element indicates an operational condition of the first process and an operational condition of the second process.

13. The GUI of claim 8, wherein a shape of the aggregate graphical display element indicates an operational condition of the first process and an operational condition of the second process.

14. A system, comprising:
an operations manager to receive Internet Protocol Television (IPTV) application data from an IPTV network, wherein the IPTV application data is associated with one or more IPTV software applications, the one or more IPTV software applications adapted to provide IPTV service to one or more subscriber premises;
a data repository to collect a portion of the IPTV application data based on one or more rules; and
a data analysis module to:
analyze the collected IPTV application data; and
send status data to a dashboard module, the status data indicating a measure of performance associated with at least a first IPTV software application of the one or more IPTV software applications.

15. The system of claim 14, further comprising a data collection layer to receive additional IPTV application data from the IPTV network.

16. The system of claim 15, wherein the additional IPTV application data is associated with a second IPTV software application of the one or more IPTV software applications.

17. The system of claim 14, wherein the dashboard module is adapted to determine that a condition meriting attention is present in the IPTV network based on the status data, and to automatically identify at least one error resolution command to correct the condition meriting attention.

18. The system of claim 17, wherein the dashboard module automatically sends that at least one error resolution command.

19. The system of claim 17, wherein the dashboard module generates a context menu including information identifying the at least one error resolution command, and sends the at least one error resolution command in response to user input.

20. A system, comprising:
a data repository to:
receive first application data from a first server of an Internet Protocol Television (IPTV) network, the first application data associated with one or more first IPTV software applications, the one or more first IPTV software applications adapted to provide IPTV service to a first group of subscriber premises; and
receive second application data from a second server of an Internet Protocol Television (IPTV) network, the second application data associated with one or more second IPTV software applications, the one or more second IPTV software applications adapted to provide IPTV service to one or more subscriber premises; and
a data analysis module to:
analyze the first application data to determine a condition of at least one of the first IPTV software applications;
analyze the second application data to determine a condition of at least one of the second IPTV software applications; and
to send condition data to a graphical user interface module, the condition data indicating a metric associated with providing IPTV service to the first group of subscriber premises, the second group of subscriber premises, or any combination thereof.

21. The system of claim 20, wherein the first server is associated with a super head-end office of the IPTV network and the second server is associated with a video head-end office of the IPTV network.
